(19) United States
(12) Patent Application Publication
(10) Pub. No.: US 2011/0154218 A1
(43) Pub. Date: Jun. 23, 2011

(54) APPARATUS AND METHOD FOR PROVIDING MULTI-LAYER DIGITAL CALENDAR

(75) Inventor: Moon-sang LEE, Suwon-si (KR)

(73) Assignee: SAMSUNG ELECTRONICS CO., LTD., Suwon-si (KR)

(21) Appl. No.: 12/754,997

(22) Filed: Apr. 6, 2010

(30) Foreign Application Priority Data
Dec. 18, 2009 (KR) 10-2009-0126928

(51) Int. Cl. G06F 3/01

(52) U.S. Cl. 715/751

(57) ABSTRACT

A multi-layer digital calendar providing method is provided. The method includes selecting a first calendar and a second calendar; generating a first meta-calendar by combining the first calendar and the second calendar; and adding list information and additional information related to the first calendar and the second calendar to the first meta-calendar.

### CROSS-REFERENCE TO RELATED PATENT APPLICATION

This application claims priority from Korean Patent Application No. 10-2009-0126928, filed Dec. 18, 2009, in the Korean Intellectual Property Office, the disclosure of which is incorporated herein in its entirety by reference.

### BACKGROUND

1. Field

Apparatuses and methods consistent with exemplary embodiments relate to providing a digital calendar, and more particularly, to providing a multi-layer digital calendar that allows a user intuitive input-output (I/O) with a multimedia terminal.

2. Description of the Related Art

In general, multimedia terminals may provide a digital calendar for sharing a user's schedule with other users' schedules. The digital calendar may display a user's schedule and various types of contents including pictures, music, moving pictures, commercial films, and the like.

The digital calendar may display schedules of different users.

In general, the digital calendar determines which schedules are to be displayed on a calendar of a main screen according to calendar check boxes selected.

However, with a great number of calendars displayed on the same screen, a user needs to scroll a calendar list to select one of the calendars, or to repeatedly select the calendar check boxes

Further, when the calendars include calendars of different types, such as, for example, calendars related to appointments with friends and calendars related to a college festival schedule, the user needs to repeatedly perform check/uncheck operations on calendar check boxes. These operations are cumbersome and may cause an inconvenience to the user.

### SUMMARY

Exemplary embodiments may address at least the above problems and/or disadvantages and other disadvantages not described above. Also, exemplary embodiments are not required to overcome the disadvantages described above, and an exemplary embodiment may not overcome any of the problems described above.

Exemplary embodiments provide a multi-layer digital calendar providing method involving grouping similar calendars into calendar groups, displaying the calendar groups, separating or deleting each calendar from the calendar groups, and combining the similar calendars in a multimedia terminal having a limited input-output (I/O) manner.

According to an aspect of an exemplary embodiment, there is provided a multi-layer digital calendar providing method including the operations of selecting a first calendar and a second calendar; generating a first meta-calendar by combining the first calendar and the second calendar; and adding list information and additional information related to the first calendar and the second calendar to the first meta-calendar.

The first meta-calendar may include information about schedules stored in the first calendar and the second calendar.

The multi-layer digital calendar providing method may further include the operations of generating a second meta-calendar by combining the first meta-calendar and a third calendar; and adding list information and additional information related to each of the first calendar, the second calendar, and the third calendar to the second meta-calendar.

The second meta-calendar may include information about schedules stored in the first calendar and the second calendar of the first meta-calendar, and the third calendar.

The multi-layer digital calendar providing method may further include the operations of generating a third meta-calendar by combining the first meta-calendar and the second meta-calendar; and adding list information and additional information related to each of the first calendar, the second calendar, and the third calendar to the third meta-calendar.

The third meta-calendar may include information about schedules stored in the first calendar and the second calendar of the first meta-calendar, and the third calendar of the second meta-calendar.

According to another aspect of an exemplary embodiment, there is provided a multi-layer digital calendar providing method including the operations of displaying a list of one or more meta-calendars by referring to additional information of the one or more meta-calendars each formed by combining one or more calendars; receiving a signal for selecting a specific meta-calendar from the list of the one or more meta-calendars; and displaying schedules and lists of the one or more calendars by referring to the additional information of the specific meta-calendar according to the signal for selecting the specific meta-calendar.

The operation of displaying the schedules and the lists may include the operations of when selection of the meta-calendar displayed on the calendar screen is maintained for a predetermined time period, displaying the schedules of the one or more calendars stored in the specific meta-calendar; and when selection of the meta-calendar displayed on the calendar screen is maintained for a predetermined time period, displaying the list of the one or more calendars stored in the specific meta-calendar.

According to another aspect of an exemplary embodiment, there is provided a multi-layer digital calendar providing method including the operations of displaying a list of one or more meta-calendars each formed by combining one or more calendars; displaying a list of the one or more calendars stored in a specific meta-calendar from the list of the one or more meta-calendars; and receiving a signal for deleting the specific meta-calendar from the list of the one or more meta-calendars, removing the one or more calendars stored in the specific meta-calendar, and then deleting the specific meta-calendar.

The operation of removing the one or more calendars may include the operations of selecting the list of the one or more calendars displayed in an area of the specific meta-calendar, and when dragged from the selected point by a predetermined distance, removing the one or more calendars.

According to another aspect of an exemplary embodiment, there is provided a multi-layer digital calendar providing method including the operations of displaying a list of one or more meta-calendars each formed by combining one or more calendars; when a specific meta-calendar is selected from the list of the one or more meta-calendars, displaying a list of the one or more calendars stored in the specific meta-calendar; receiving a list selection signal for selecting a calendar from among the one or more calendars in the list, and a target metal-calendar selection signal for selecting a target meta-calendar from among the one or more meta-calendars; and combining the calendar selected from among the one or more calendars to the target metal-calendar.

The multi-layer digital calendar providing method may further include the operation of generating a new meta-calendar when only the list selection signal for selecting the one or more calendars is received.

According to another aspect of an exemplary embodiment, there is provided a multi-layer digital calendar providing apparatus including an input unit for detecting a touch signal for selecting a calendar; and a control unit for generating one or more meta-calendars each generated by combining one or more calendars, displaying a list of the one or more meta-calendars, and when a meta-calendar selection signal is detected by the input unit, displaying schedules or lists of the one or more calendars stored in the one or more meta-calendars.

When a calendar from among the one or more calendars is selected, the control unit may unite the calendar to a target meta-calendar.

### BRIEF DESCRIPTION OF THE DRAWINGS

The above and other aspects will become more apparent by describing in detail certain exemplary embodiments with reference to the accompanying drawings, in which:

FIG. 1 is a block diagram of a multi-layer digital calendar providing apparatus according to an exemplary embodiment;

FIG. 2 is a diagram of a configuration of a multi-layer digital calendar according to another exemplary embodiment;

FIG. 3A is a flowchart of a multi-layer calendar generating method, according to an exemplary embodiment;

FIG. 3B is a flowchart of a multi-layer calendar generating method, according to another exemplary embodiment;

FIG. 3C is a flowchart of a multi-layer calendar generating method, according to another exemplary embodiment;

FIG. 4 is a flowchart of a multi-layer calendar generating method, according to another exemplary embodiment;

FIG. 5 is a flowchart of a method of separating and deleting calendars in a multi-layer calendar, according to an exemplary embodiment;

FIG. 6 is a flowchart of a method of combining calendars in a multi-layer calendar, according to an exemplary embodiment; and

FIG. 7 is an illustration of a screen of a multi-layer digital calendar according to an exemplary embodiment.

### DETAILED DESCRIPTION OF EXEMPLARY EMBODIMENTS

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters.

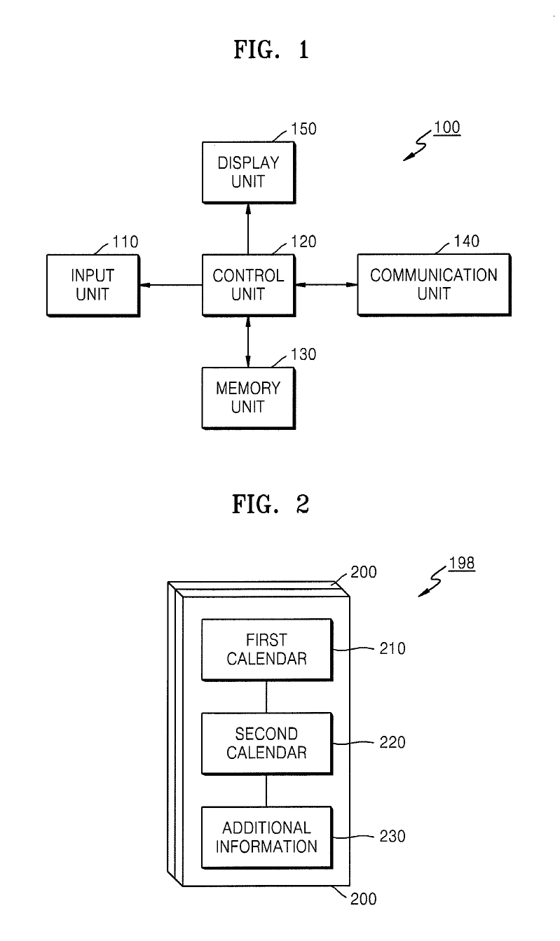

FIG. 1 is a block diagram of a multi-layer digital calendar providing apparatus according to an exemplary embodiment.

The multi-layer digital calendar providing apparatus 100 of FIG. 1 includes an input unit 110, a control unit 120, a memory unit 130, a communication unit 140, and a display unit 150.

The input unit 110 may be mounted on the display unit 150, or may be formed to be independent of the display unit 150 and mounted at a position separate from the display unit 150.

The input unit 110 may include a touch panel, a manipulation input device, such as a keyboard or a mouse, one or more buttons, one or more direction keys, but is not limited thereto.

When the input unit 110 is touched to perform a calendar selection, the input unit 110 detects the touch by detecting a change in a physical quantity of the input unit 110, as for example, a change in a storage quantity or a capacitance quantity, and transforms the change in the physical quantity due to the touch into a touch signal.

The display unit 150 may display various pieces of information and control commands generated by the control unit 120. The display unit 150 may be a liquid crystal display (LCD), but is not limited thereto.

The memory unit 130 stores at least one meta-calendar formed by combining a program or control data for driving the control unit 120, and one or more calendars.

The memory unit 130 may include a magnetic recording medium, such as a hard disk, an Electrically Erasable Programmable Read-Only Memory (EEPROM), or a non-volatile memory, such as a flash memory, but types of the memory unit 130 are not limited thereto.

The communication unit 140 modulates and amplifies a signal generated by the control unit 120 into a signal within a desired frequency band, and amplifies and demodulates a radio frequency (RF) signal received via a network into a signal within a desired frequency band.

The control unit 120 is formed of a micro-processing unit (MPU) or an integrated circuit, in which a plurality of circuits for performing a control function are integrated, and controls overall operations of a multimedia terminal.

The control unit 120 exchanges calendar information with the peripheral devices by using the communication unit 140, and detects a touch operation, such as in a drag and drop operation, occurring on the touch panel of the input unit 110.

The control unit 120 sets a new meta-calendar by combining files of one or more calendars, displays a list of the meta-calendars on the display unit 150, and displays schedules and lists of the calendars included in one of the meta-calendars when the meta-calendar is selected via the input unit 110, and unites the calendar to a target meta-calendar when one of the calendars is selected.

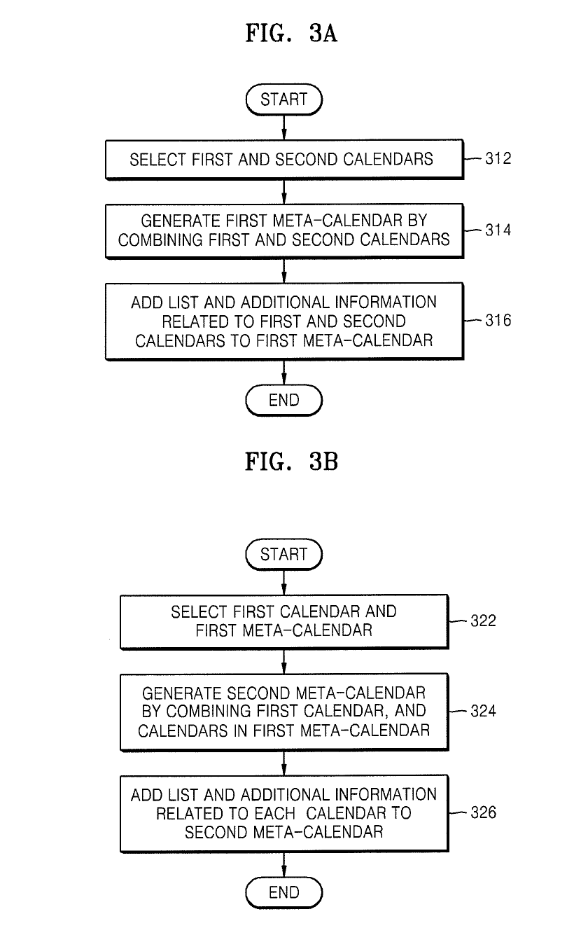

FIG. 2 is a diagram of a configuration of a multi-layer digital calendar according to an exemplary embodiment.

The multi-layer digital calendar 198 of FIG. 2 may be formed of a plurality of meta-calendars 200. Each meta-calendar 200 is set so that one or more calendars are combined. For example, each meta-calendar 200 may be formed of one or more calendars dealing with similar subjects.

For example, each meta-calendar 200 may include a first calendar 210, a second calendar 220, and additional information 230. Each of the first calendar 210 and the second calendar 220 includes schedule information, a calendar title, a calendar generation date, a calendar generator, and a share list.

The additional information 230 includes a meta-calendar title, a meta-calendar generation date, a meta-calendar generator, and description information about the first and second calendars 210 and 220.

Thus, according to the present exemplary embodiment, a combination of calendars dealing with similar subjects may be set as a calendar group, and each of the calendars included in the calendar group may be easily selected.

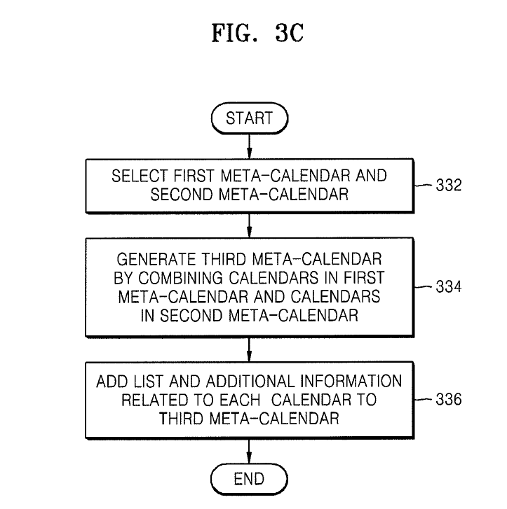

FIG. 3A is a flowchart of a multi-layer calendar generating method, according to an exemplary embodiment.

A first calendar and a second calendar that are similar in type to each other are selected by a user (operation 312). For example, the first and second calendars deal with similar subjects.

A first meta-calendar as a new calendar group is generated by combining the first calendar and the second calendar (operation 314). That is, a calendar group is set similarly to a folder or a directory of a file system. Calendar files dealing with the similar subjects are included in the calendar group.

List information and additional information related to the first and second calendars are added to the first meta-calendar (operation 316).

For example, the first meta-calendar includes information about schedules stored in the first and second calendars.

FIG. 3B is a flowchart of a multi-layer calendar generating method, according to another exemplary embodiment.

A first calendar and a first meta-calendar are selected by a user (operation 322). For example, the first calendar and the first meta-calendar deal with the similar subjects. The first meta-calendar is formed of one or more calendars dealing with the similar subjects.

A second meta-calendar as a new calendar group is generated by combining the first calendar, and the calendars included in the first meta-calendar (operation 324).

After that, list information and additional information related to each of the first calendar and the calendars of the first meta-calendar are added to the second meta-calendar (operation 326).

For example, the second meta-calendar includes the information about schedules stored in the first calendar and the information about schedules of the calendars of the first meta-calendar.

FIG. 3C is a flowchart of a multi-layer calendar generating method, according to another exemplary embodiment.

A first meta-calendar and a second meta-calendar are selected by a user (operation 332). For example, the first meta-calendar and the second meta-calendar deal with the similar subjects. Each of the first meta-calendar and the second meta-calendar includes one or more calendars dealing with the similar subjects.

A third meta-calendar as a new calendar group is generated by combining the calendars of the first meta-calendar, and the calendars of the second meta-calendar (operation 334).

After that, list information and additional information related to each of the calendars of the first and second meta-calendars are added to the third meta-calendar (operation 336). For example, the third meta-calendar includes information about schedules stored in each of the calendars of the first and second meta-calendars.

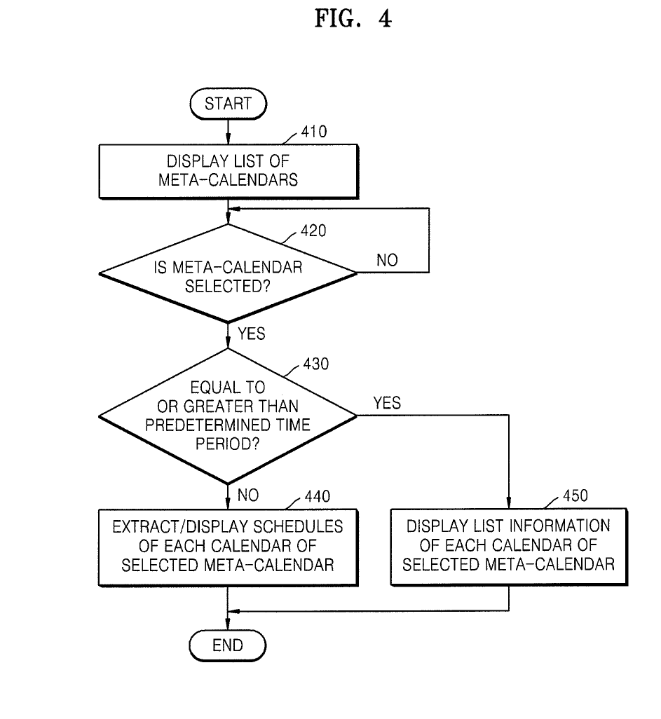

FIG. 4 is a flowchart of a multi-layer calendar generating method, according to another exemplary embodiment.

A list of the meta-calendars is displayed on a screen by referring to additional information added to the meta-calendars, when one or more calendars are combined in the meta-calendars (operation 410). The list of the meta-calendars may include one or more meta-calendars.

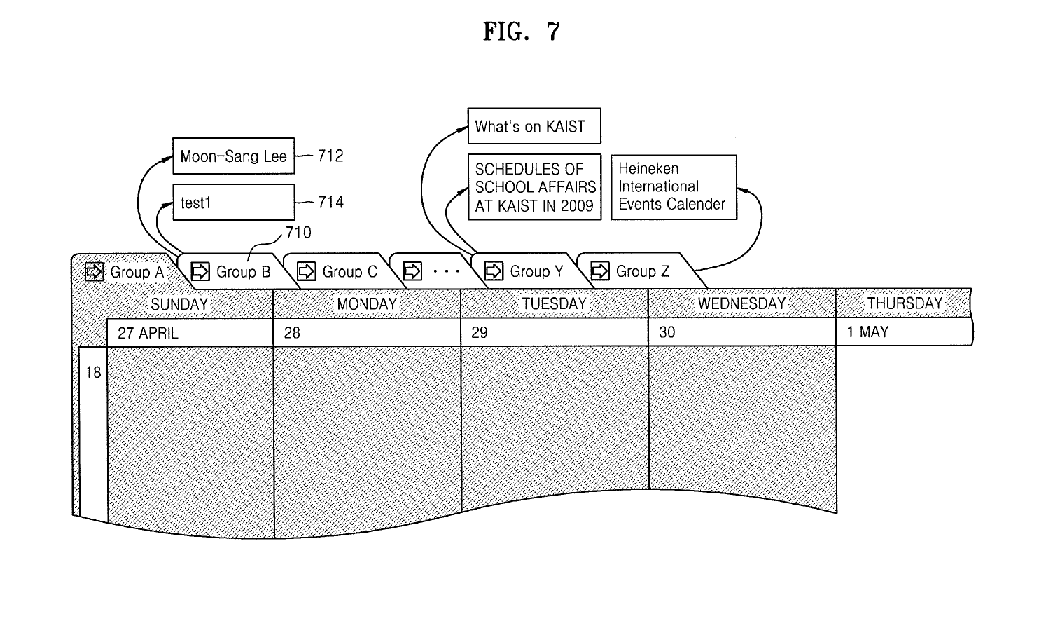

Referring to FIG. 7, schedules of a plurality of calendars are displayed on the same calendar screen. Group A, group B, group C, . . . , group Y, and group Z shown on the calendar screen are meta-calendars. The groups may be titled by a user. Each of the meta-calendars has an associated calendar list including one or more calendars. For example, a meta-calendar of the group B has a list of calendars including a first calendar/schedule 712 entitled “Moon-Sang Lee” and a second calendar/schedule 714 entitled “test1”.

Referring again to FIG. 4, it is checked whether a meta-calendar is selected from the list of the meta-calendars displayed on the calendar screen (operation 420). If the meta-calendar is selected, it is checked whether the selection of the selected meta-calendar displayed on the calendar screen is maintained for a predetermined time period (operation 430).

If the selection of the selected meta-calendar is maintained for the predetermined time period, list information about the calendars included in the selected meta-calendar is displayed on the calendar screen by referring to the additional information added to the selected meta-calendar (operation 450).

Referring to FIG. 7, when a pointing device, such as a mouse pointer, selects a tab representing a meta-calendar, as for example, a screen area 710 of the group B for the predetermined amount of time, a list of calendars, such as the first calendar/schedule 712 entitled “Moon-Sang Lee” and the second calendar/schedule 714 entitled “test1”, corresponding to the meta-calendar corresponding to the tab selected is displayed above the selected tab, as for example, above the screen area 710 of the group B.

For example, when a user selects a tab via a mouse click, a touch screen touch, or a key input to select a meta-calendar, a list of calendars included in the selected meta-calendar may be displayed for some amount of time.

However, when the meta-calendar input selection function is maintained for an amount of time less than the predetermined time period, schedules of each calendar included in the selected meta-calendar are extracted, and displayed on the calendar screen (operation 440).

In another exemplary embodiment, when the number of meta-calendars is such that an area occupied by the tabs of the meta-calendars is greater than a specific area of a screen, a scroll bar or scroll direction display buttons may be displayed on the screen so that left and right scrolling operations may be performed to display the tabs of the meta-calendars.

According to a selection signal input status with respect to the meta-calendars displayed on the screen, the schedules of each calendar and the list information about the calendars are displayed by referring to the additional information included in the meta-calendars.

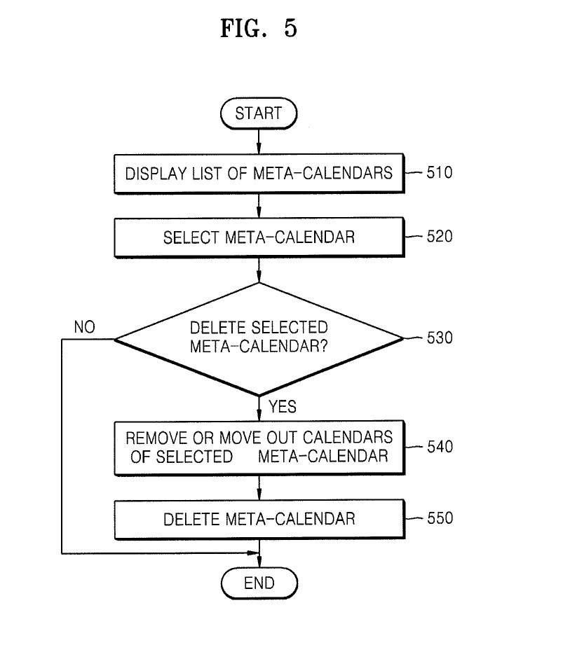

FIG. 5 is a flowchart of a method of separating and deleting calendars in a multi-layer calendar, according to an exemplary embodiment.

A list including one or more meta-calendars each formed by combining one or more calendars is displayed on a screen (operation 510). A list of one or more calendars included in each of the meta-calendars is displayed above a tab representing each of the meta-calendars.

A meta-calendar is selected from the list of the meta-calendars displayed on the screen (operation 520). For example, as illustrated in FIG. 7, a meta-calendar may be selected from a list of meta-calendars via a touch of a corresponding tab. For example, the meta-calendar includes a list of calendars including the first calendar/schedule 712 entitled “Moon-Sang Lee” and the second calendar/schedule 714 entitled “test1” that are displayed above a tab 710 of a group B.

Whether to remove the selected meta-calendar is determined (operation 530).

If the selected meta-calendar is to be removed, all of the calendars included in the selected meta-calendar are removed (operation 540). However, a particular calendar may be selected from the list of the calendars included in the selected meta-calendar, dragged and dropped into a different area of a screen, to move out the selected calendar from the meta-calendar selected for deletion.

For example, if the first calendar/schedule 712 entitled “Moon-Sang Lee” displayed above the tab 710 of the meta-calendar group B, shown in FIG. 7, is touched and dragged from the touch point a predetermined distance, the first calendar/schedule 712 entitled “Moon-Sang Lee” is removed from the meta-calendar group B. The rest of calendars are left in the meta-calendar group B.

After the calendars of the meta-calendar are removed or moved out, the selected meta-calendar is removed (operation 550).

Although the meta-calendar is removed, its calendars exist in a logic space, and thus, a new meta-calendar may be generated at a later time by using the individual calendars.

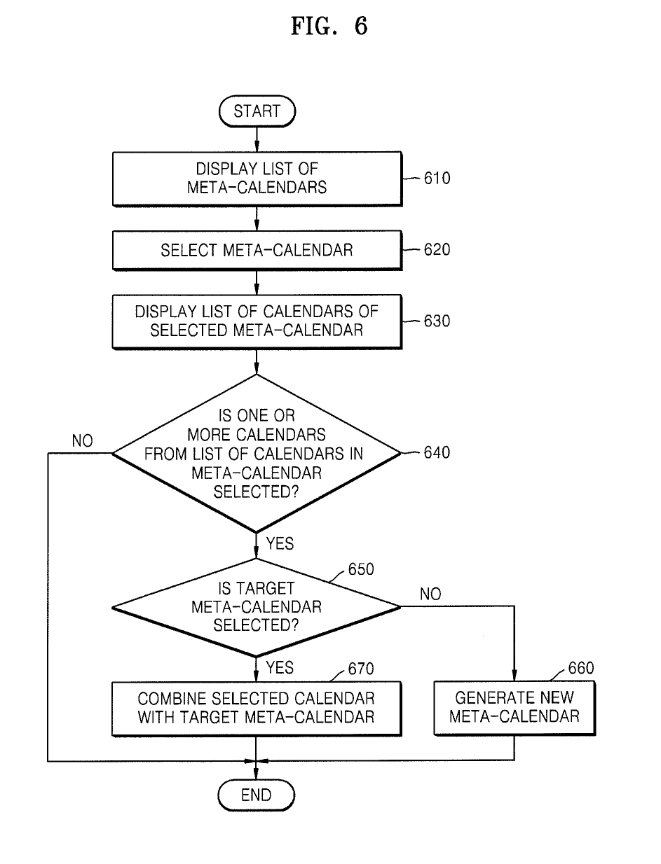

FIG. 6 is a flowchart of a method of combining calendars in a multi-layer calendar, according to an exemplary embodiment.

Calendars included in a meta-calendar may be added from a calendar list by performing a drag and drop operation.

A list of one or more meta-calendars each formed by combining one or more calendars is displayed on a screen (operation 610).

A meta-calendar is selected from the list of the meta-calendars displayed on the screen (operation 620).

A list of calendars included in the selected meta-calendar is displayed on the screen (operation 630).

It is checked whether at least one calendar is selected from the list of the calendars (operation 640).

A target meta-calendar is selected by performing dragging the selected calendar to the target meta-calendar and dropping the calendar into an area of the screen representing the target meta-calendar (operation 650).

The selected and dropped calendar is combined with the target meta-calendar (operation 670). For example, if a first meta-calendar includes one calendar and a second meta-calendar includes two calendars, the calendar of the first meta-calendar displayed on a screen may be dragged to and dropped on the second meta-calendar so that one additional calendar is added to the second meta-calendar. Accordingly the second meta-calendar may have a total of three calendars. For example, the first meta-calendar may be maintained on the screen, or may be automatically deleted from the screen.

When the calendar is dragged to and dropped on an area of the screen which does not represent a meta-calendar, a new meta-calendar may be generated (operation 660).

According to one or more exemplary embodiments, calendar groups may be generated a plurality of times as desired by a user, calendars included in each of the calendar groups may be easily selected, and schedules of the calendars may be displayed on the same calendar screen.

Exemplary embodiments may be embodied as computer-readable codes on a computer-readable recording medium. The computer-readable recording medium may include a data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network coupled computer systems so that the computer-readable code is stored and executed in a distributed fashion.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A multi-layer digital calendar providing method comprising:
selecting a first calendar and a second calendar;
generating a first meta-calendar by combining the first calendar and the second calendar; and
adding list information and additional information related to the first calendar and the second calendar to the first meta-calendar.

2. The multi-layer digital calendar providing method of claim 1, wherein the first meta-calendar comprises information about schedules stored in the first calendar and the second calendar.

3. The multi-layer digital calendar providing method of claim 1, further comprising:
generating a second meta-calendar by combining the first meta-calendar and a third calendar; and
adding the list information and the additional information related to each of the first calendar, the second calendar, and the third calendar to the second meta-calendar.

4. The multi-layer digital calendar providing method of claim 3, wherein the second meta-calendar comprises the information about the schedules stored in the first calendar and the second calendar of the first meta-calendar, and the third calendar.

5. The multi-layer digital calendar providing method of claim 3, further comprising:
generating a third meta-calendar by combining the first meta-calendar and the second meta-calendar; and
adding the list information and the additional information related to each of the first calendar, the second calendar, and the third calendar to the third meta-calendar.

6. The multi-layer digital calendar providing method of claim 5, wherein the third meta-calendar comprises the information about the schedules stored in the first calendar and the second calendar of the first meta-calendar, and the third calendar of the second meta-calendar.

7. A multi-layer digital calendar providing method comprising:
displaying a list including one or more meta-calendars by referring to additional information of the meta-calendars each formed by combining one or more calendars;
receiving a signal for selecting a meta-calendar from the list of the meta-calendars; and
displaying schedules and lists of the calendars by referring to the additional information of the selected meta-calendar according to the signal for selecting the meta-calendar.

8. The multi-layer digital calendar providing method of claim 7, wherein the displaying of the schedules and the lists comprises:
when selection of the meta-calendar displayed on the calendar screen is maintained for less than a predetermined time period, displaying the schedules of the calendars stored in the selected meta-calendar; and
when selection of the meta-calendar displayed on the calendar screen is maintained for a predetermined time period, displaying the list of the calendars stored in the selected meta-calendar.

9. A multi-layer digital calendar providing method comprising:
displaying a list including one or more meta-calendars each formed by combining one or more calendars;
displaying a list of the calendars stored in one of the meta-calendars selected from the list of the meta-calendars;
receiving a signal for deleting the selected meta-calendar from the list of the meta-calendars;
removing the calendars stored in the selected meta-calendar; and
deleting the selected meta-calendar.

10. The multi-layer digital calendar providing method of claim 9, wherein the removing of the calendars comprises selecting one or more calendars displayed in an area of a screen corresponding to the selected meta-calendar, and the method further comprises moving the selected one or more calendars by dragging a selected point of the screen area by a predetermined distance.

11. A multi-layer digital calendar providing method comprising:
displaying a list including one or more meta-calendars each formed by combining one or more calendars;
when a meta-calendar is selected from the list of the meta-calendars, displaying a list of the calendars stored in the selected meta-calendar;
receiving a list selection signal for selecting a calendar from the displayed list of calendars;
receiving a target meta-calendar selection signal for selecting a target meta-calendar from the displayed list of meta-calendars; and
combining the calendar selected from the list of calendars with the target meta-calendar.

12. The multi-layer digital calendar providing method of claim 11, further comprising generating a new meta-calendar when only the list selection signal for selecting the calendar is received and omitting the combining the calendar.

13. A multi-layer digital calendar providing apparatus comprising:
an input unit which detects a touch signal for selecting a calendar; and
a control unit which generates one or more meta-calendars each being generated by combining one or more calendars, displays a list including one or more meta-calendars, and when a meta-calendar selection signal is detected by the input unit, displays schedules or lists of the calendars stored in the meta-calendars.

14. The multi-layer digital calendar providing apparatus of claim 13, wherein, when a calendar from the list of calendars is selected, the control unit combines the selected calendar with a target meta-calendar.

15. A non-transitory computer-readable recording medium storing a program which, when executed by a computer, causes the computer to execute the multi-layer digital calendar providing method of claim 1.

16. A non-transitory computer-readable recording medium storing a program which, when executed by a computer, causes the computer to execute the multi-layer digital calendar providing method of claim 7.

17. A non-transitory computer-readable recording medium storing a program which, when executed by a computer, causes the computer to execute the multi-layer digital calendar providing method of claim 9.

18. A non-transitory computer-readable recording medium storing a program which, when executed by a computer, causes the computer to execute the multi-layer digital calendar providing method of claim 11.

19. A method comprising:
selecting a first calendar and a second calendar;
generating a first meta-calendar by combining data included in the first calendar with data included in the second calendar;
generating a calendar list including the data of the first calendar and the second calendar, in the first meta-calendar;
generating first meta-calendar information related to schedules contained in the first calendar and the second calendar, in the first meta-calendar; and
displaying a multi-layer digital calendar comprising the first meta-calendar.

20. The method of claim 19, further comprising:
selecting a third calendar;
generating a second meta-calendar by combining data of the first meta-calendar with data of the third calendar;
generating the calendar list including the data of the first calendar, the second calendar, and the third calendar, in the second meta-calendar;
generating second meta-calendar information related to schedules contained in the first calendar, the second calendar, and the third calendar, in the second meta-calendar; and
displaying the multi-layer digital calendar comprising the first meta-calendar and the second meta-calendar.

21. The method of claim 20, further comprising:
generating a third meta-calendar by combining data of the first meta-calendar and data of the second meta-calendar;
generating the calendar list including the data of the first calendar, the second calendar, and the third calendar, in the third meta-calendar;
generating third meta-calendar information related to the schedules contained in the first calendar, the second calendar, and the third calendar, in the third meta-calendar; and
displaying the multi-layer digital calendar comprising the first meta-calendar, the second meta-calendar, and the third meta-calendar.

22. The method of claim 20, further comprising:
receiving an indication of selecting a third meta-calendar in an area of a screen corresponding to the third meta-calendar, wherein the third meta-calendar comprises a fourth calendar;
receiving an indication of selecting the first calendar in an area of the screen corresponding to the first meta-calendar;
receiving an indication of de-selecting of the first calendar in the area of the screen corresponding to the third meta-calendar;
updating the calendar list of the third meta-calendar with the data of the first calendar;
updating third meta-calendar information comprising a schedule of the fourth calendar with the schedule contained in the first calendar; and
displaying the multi-layer digital calendar comprising the first meta-calendar comprising the second calendar, the second meta-calendar comprising the first, second and third calendars, and the third meta-calendar comprising the first and the fourth calendars.
